(19) United States
(12) Patent Application Publication
(10) Pub. No.: US 2003/0123089 A1
(43) Pub. Date: Jul. 3, 2003

(54) Graphics state bandwidth reduction for zone rendering

(76) Inventor: Peter L. Doyle, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/038,922

(22) Filed: Dec. 31, 2001

(51) Int. Cl. G06K 1/00; G06F 15/00; H04N 1/327

(52) U.S. Cl. 358/1.18; 358/426.08

(57) ABSTRACT

Embodiments of the present invention provide a mechanism to track and manage graphics states, in particular slow state variables, for use with a tile-based rendering architecture such as zone rendering. Slow state variables, including but not limited to infrequently changing state variables, large state variables (e.g., matrices) and state variables which require rendering pipeline flushes (e.g., texture palette changes), are maintained in a global (i.e., scene-scoped) list of slow state blocks. Since the driver software only needs to maintain a single list of slow state blocks for the entire scene, replication of slow state variables into bins is avoided.

### BACKGROUND

1. Field

The present invention relates generally to graphics systems and more particularly to graphics-rendering systems.

2. Background Information

Computer graphics systems are commonly used for displaying graphical representations of objects on a two-dimensional video display screen. Current computer graphics systems provide highly detailed representations and are used in a variety of applications. In typical computer graphics systems, an object to be represented on the display screen is broken down into graphics primitives. Primitives are basic components of a graphics display and may include points, lines, vectors and polygons, such as triangles and quadrilaterals. Typically, a hardware/software scheme is implemented to render or draw the graphics primitives that represent a view of one or more objects being represented on the display screen.

The primitives of the three-dimensional objects to be rendered are defined by a host computer in terms of primitive data. For example, when the primitive is a triangle, the host computer may define the primitive in terms of X, Y and Z coordinates of its vertices, as well as the red, green and blue (R, G and B) color values of each vertex. Additional primitive data may be used in specific applications.

Image rendering is the conversion of a high-level object-based description into a graphical image for display on some display device. For example, an act of image rendering occurs during the conversion of a mathematical model of a three-dimensional object or scene into a bitmap image. Another example of image rendering is converting an HTML document into an image for display on a computer monitor. Typically, a hardware device referred to as a graphics-rendering engine performs these graphics processing tasks. Graphics-rendering engines typically render scenes into a buffer that is subsequently output to the graphical output device, but it is possible for some rendering-engines to write their two-dimensional output directly to the output device. The graphics-rendering engine interpolates the primitive data to compute the display screen pixels that represent the each primitive, and the R, G and B color values of each pixel.

A graphics-rendering system (or subsystem), as used herein, refers to all of the levels of processing between an application program and a graphical output device. A graphics engine can provide for one or more modes of rendering, including zone rendering. Zone rendering attempts to increase overall 3D rendering performance by gaining optimal render cache utilization, thereby reducing pixel color and depth memory read/write bottlenecks. In zone rendering, a screen is subdivided into an array of zones and per-zone instruction bins, used to hold all the primitive and state setting instructions required to render each sub-image, are generated. Whenever a primitive intersects (or possibly intersects) a zone, that primitive instruction is placed in the bin for that zone. Some primitives will intersect more than one zone, in which case the primitive instruction is replicated in the corresponding bins. This process is continued until the entire scene is sorted into the bins. Following the first pass of building a bin for each zone intersected by a primitive, a second zone-by-zone rendering pass is performed. In particular, the bins for all the zones are rendered to generate the final image.

In order to implement a tile-rendering architecture like zone rendering, the maintenance of the correct graphics-rendering state variables within each image-space zone (i.e. bin) is very important, in that it is required to subsequently render (during the rendering phase) each bin's primitives with the graphics state that existed at the time the primitive was encountered during the binning phase.

One conventional method of associating primitives with their appropriate graphics state would be to separately maintain a copy of all encountered graphics states and associate each primitive with some tag (i.e. index) identifying the specific state to be later used for rendering the primitive. However, the complexity of maintaining a separate state table and the cost (in required memory footprint, latency and bandwidth) of loading complete state sets—possibly between each primitive—can be prohibitive in low-cost and bandwidth-constrained (e.g., integrated) graphics systems. For slow state variables, such as infrequently changing state variables, large state variables or state variables which require pipeline flushes, a less costly and less direct state setting mechanism is desired.

What is needed therefore is a method, apparatus and system for graphics state management of slow state variables for zone rendering that is less costly and more efficient.

### BRIEF DESCRIPTION OF THE DRAWINGS

FIG. 1 illustrates a block diagram of an embodiment of a computer system including an embodiment of a graphics device for management of slow state variables for zone rendering.

FIG. 2 illustrates a block diagram of an embodiment of a graphics device including a graphics-binning engine for processing a scene input list including delta states, graphics-rendering engine and bins.

FIG. 3 illustrates a depiction of an embodiment of a zone renderer screen view including zones and geometrical primitives.

FIG. 4 illustrates a block diagram of an embodiment of dynamic state subgroups and per-bin tracking bits.

FIG. 5 illustrates a block diagram of an embodiment of a slow state block.

FIG. 6 illustrates a flow diagram of an embodiment of a process for generating slow state blocks during scene binning.

FIG. 7 illustrates a flow diagram of an embodiment of a process for generating slow state blocks during scene binning.

FIG. 8 illustrates a flow diagram of an embodiment of a process for handling slow state update commands.

### DETAILED DESCRIPTION

Embodiments of the present invention provide a cost-effective mechanism to track and manage graphics states, in particular slow state variables, for use with a tile-based rendering architecture such as zone rendering. In zone rendering, the maintenance of the correct graphics rendering state variables within each zone (and associated bin) is important. Slow state variables, including but not limited to infrequently changing state variables, large state variables (e.g., matrices) and state variables which require rendering pipeline flushes (e.g., texture palette changes), are maintained in a global (i.e., scene-scoped) list of slow state blocks. Since the driver software only needs to maintain a single list of slow state blocks for the entire scene, replication of slow state variables into bins is avoided. Depending on the size of a scene and slow state block, the list may be comprised of a plurality of slow state blocks for any given scene. Slow state blocks are not logically linked, and can be allocated in any order.

For frequently changing state variables, it is desirable to maintain the current values of those states in the binning hardware in order to allow for the insertion and/or replication of the state directly into the bin data structures. The replication of state variables into bin lists is typically required when large area-wise primitives are encountered—where the correct rendering state of multiple bins must be output into the associated bin lists. In such case, the number of bins can be large (i.e. in the hundreds).

In the detailed description, numerous specific details are set forth in order to provide a thorough understanding of the present invention. However, it will be understood by those skilled in the art that the present invention maybe practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a micro-controller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

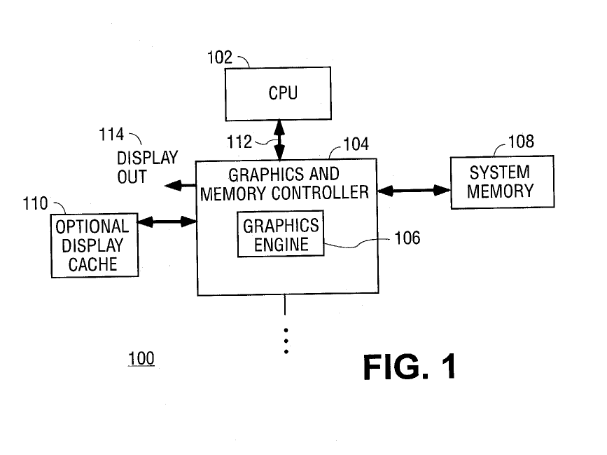

An example of one such type of processing system is shown in FIG. 1. Sample system 100 may be used, for example, to execute the processing for methods in accordance with the present invention, such as the embodiment described herein. Sample system 100 is representative of processing systems based on the microprocessors available from Intel Corporation, although other systems (including personal computers (PCs) having other microprocessors, engineering workstations, set-top boxes and the like) may also be used. In one embodiment, sample system 100 may be executing a version of the WINDOWS.™ operating system available from Microsoft Corporation, although other operating systems and graphical user interfaces, for example, may also be used.

FIG. 1 is a block diagram of a system 100 of one embodiment of the present invention. The computer system 100 includes central processor 102, graphics and memory controller 104 including graphics device 106, memory 108 and display device 114. Processor 102 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Processor 102 may be coupled to common bus 112 that transmits data signals between processor 102 and other components in the system 100. FIG. 1 is for illustrative purposes only. The present invention can also be utilized in a configuration including a descrete graphics device.

Processor 102 issues signals over common bus 112 for communicating with memory 108 or graphics and memory controller 104 in order to manipulate data as described herein. Processor 102 issues such signals in response to software instructions that it obtains from memory 108. Memory 108 may be a dynamic random access memory (DRAM) device, a static random access memory (SRAM) device, or other memory device. Memory 108 may store instructions and/or data represented by data signals that may be executed by processor 102, graphics device 106 or some other device. The instructions and/or data may comprise code for performing any and/or all of the techniques of the present invention. Memory 108 may also contain software and/or data. An optional cache memory 110 may be used to speed up memory accesses by the graphics device 106 by taking advantage of its locality of access. In some embodiments, graphics device 106 can offload from processor 102 many of the memory-intensive tasks required for rendering an image. Graphics device 106 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Graphics device 106 may be coupled to common bus 112 that transmits data signals between graphics device 106 and other components in the system 100, including render cache 110 and display device 114. Graphics device 106 includes rendering hardware that among other things writes specific attributes (e.g. colors) to specific pixels of display 114 and draw complicated primitives on display device 114. Graphics and memory controller 104 communicates with display device 114 for displaying images rendered or otherwise processed by a graphics controller 104 for displaying images rendered or otherwise processed to a user. Display device 114 may comprise a computer monitor, television set, flat panel display or other suitable display device.

Memory 108 stores a host operating system that may include one or more rendering programs to build the images of graphics primitives for display. System 100 includes graphics device 106, such as a graphics accelerator that uses customized hardware logic device or a co-processor to improve the performance of rendering at least some portion of the graphics primitives otherwise handled by host rendering programs. The host operating system program and its host graphics application program interface (API) control the graphics device 106 through a driver program.

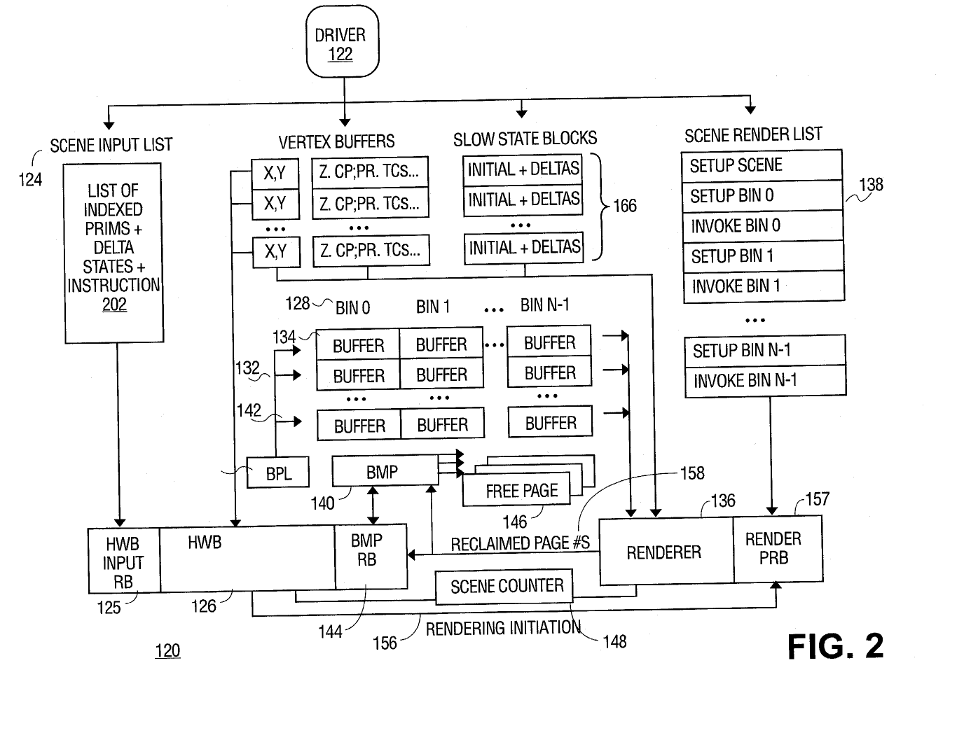

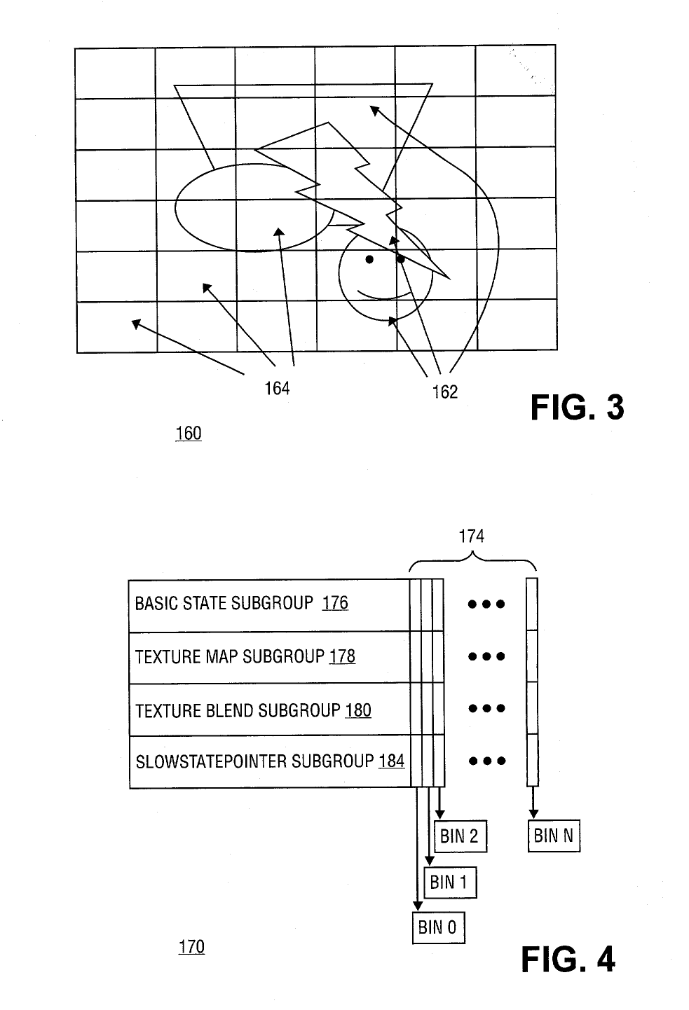

Referring to FIGS. 2 and 3, an embodiment 160 of various graphics objects, for example geometric primitives (i.e. triangles, lines) 162, implemented on a zone rendering system 120 is illustrated. In zone rendering, a screen is subdivided into an array of zones 164 commonly screen-space rectangles although other geometric variants may be used as well. Each zone 164 is associated with a bin. Each bin 128 includes a chained series of command buffers 134 stored within non-contiguous physical memory pages. The bins 128 are thus preferably implemented as a chain of independent physical pages.

When a primitive 162 intersects a zone 164, the corresponding primitive instruction is placed in the bin 128 associated with the zone 164 intersected. Per-zone instruction bins 128 are thus used to hold primitive instructions and state setting instructions required to render each sub-image and are generated by comparing the screen-space extent of each primitive 162 to the array of zones 164. Thus, as the primitives 162 are received, the present invention determines which zone(s) 164 each primitive 162 intersects, and replicates the primitive instructions into a bin 128 associated with each of these zones 164. The process of assigning primitives (and their attributes) 142 to zones 164 is referred to as binning. “Bin”128 refers to the abstract buffer used for each zone—where a bin 128 will typically be realized as a series of instruction batch buffers 134. Binning performs the necessary computations to determine what primitives 162 lie in what zones 164 and can be performed by dedicated hardware and/or software implementations. In one typical implementation, a driver 122 writes out a set of commands to be parsed by the graphics-binning engine 126 for each zone 164 intersected by a primitive 162 and the commands are written into buffers 134 associated with the zones 164 intersected.

Some primitives 162 will intersect more than one zone 164, in which case the primitive instruction is replicated in bins 128 corresponding to the intersected zones 164. For example, the lightening bolt depicted in FIG. 3 intersects nine zones 164. This process is continued until the entire scene is sorted into bins 128.

Once all the primitives 162 are sorted and the command structures completed, a second pass is made to render the scene one zone 164 at a time. Following the first pass of building a bin for each zone 164 intersected by a primitive 162, a second zone-by-zone rendering pass is performed. In particular, the bins 128 for all the zones 164 are rendered to generate the final image, with each scene rendered one zone 164 at a time. The order with which the zones 164 are rendered is not significant. All bins 128 associated with primitives 162 that touch pixels within a particular zone 164 are rendered before the next zone 164 is rendered. A single primitive 162 may intersect many zones 164, thus requiring multiple replications. As a result, primitives 162 that intersect multiple zones 164 are rendered multiple times (i.e. once for each zone 164 intersected).

Rendering performance improves as a result of the primitives 162 being decomposed into zones 164 that are aligned to the render cache 110. Since the graphics device 106 is only working on a small portion of the screen at a time (i.e. a zone 164), it is able to hold the frame buffer contents for the entire zone 164 in a render cache 110. The dimensions of the zone 164 are typically a constant tuned to the size and organization of the render cache 110. It is by this mechanism that the render cache 110 provides optimal benefits—reuse of cached data is maximized by exploiting the spatial coherence of a zone 164. Through use of the zone rendering mode, only the minimum number of color memory writes need be performed to generate the final image one zone 164 at a time, and color memory reads and depth memory reads and writes can be minimized or avoided altogether. Use of the render cache 110 thus significantly reduces the memory traffic and improves performance relative to a conventional renderer that draws each primitive completely before continuing to the next primitive.

Referring to FIG. 2, in a typical implementation, a graphics primitive and state-setting instruction stream, referred to as a scene input list 124, is initially applied to graphics-binning engine ring buffer 125 associated with graphics-binning engine 126. The scene input list 124 may be a single, temporally-ordered scene description (as received by the application programming interface). Graphics-binning engine 126 is typically implemented as a hardware binning engine (HWB) 126. One skilled in the art will recognize that a software or software plus hardware binner could be used as well. The graphics-binning engine 126 parses scene input list 124 and determines which zone(s) 164 each primitive 162 intersects.

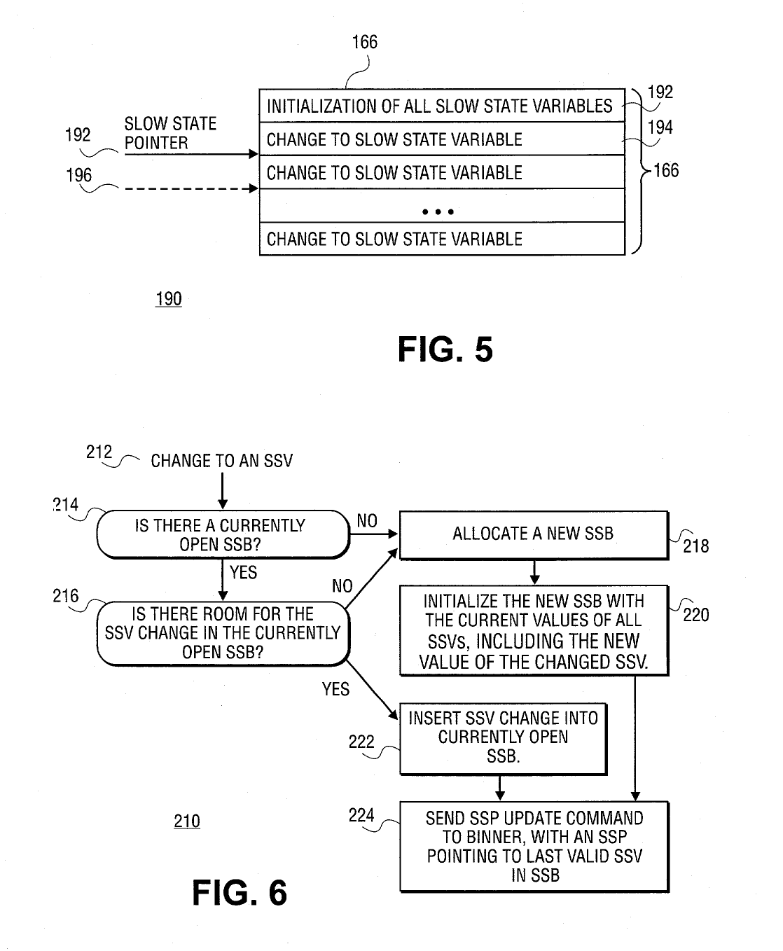

As previously noted, the zones 164 are associated with bins 128. Graphics-binning engine 126 compares the screen-space extent of each primitive 162 to the array of zones 164, and replicates the associated primitive commands into corresponding bins 128. As shown in FIG. 5 and described in detail below, bins 128 are comprised of chained series of command buffers 134 typically stored within non-contiguous physical memory pages. A bin list is a list of buffers 134 which comprise each bin 132. Pages are initially allocated to the BMP 140. The bin pointer list 130 is initialized with the page numbers of the pages and stores a write pointer into the bin list 132.

The graphics-binning engine 126 also maintains the current graphics state by parsing associated state-setting instructions contained with the scene input list 124. Prior to placing a primitive command in any given bin 128, the graphics-binning engine 126 typically precedes the primitive command in the bin 128 with any required state-setting instructions.

After the scene input list 124 has been completely parsed, the associated bins (i.e. bin 0, bin 1 . . . bin n−1) are ready to be used by the graphics-rendering engine 136 to render the scene. As discussed in detail below, instructions are included at the end of the scene input list 124 to cause the graphics-binning engine 126 to increment the register in pending scene counter 148 by one and initiate rendering of the binned scene. For example, graphics-binning engine 126 sends a render instruction to graphics-rendering engine ring buffer 157 associated with graphics-rendering engine 136 via path 156.

FIG. 4 illustrates a block diagram of an embodiment 170 of current dynamic state subgroups 172 and per-bin tracking bits 174. The subdivision of dynamic states into subgroups 172 provides a level of granularity for tracking and effecting changes to the dynamic state variables. In a typical embodiment, the set of dynamic state variables is subdivided into four subgroups 172, including slow state pointer subgroup 182. One skilled in the art will recognize that four subgroups 172 are advantageous for the configuration shown and discussed herein, however, the present invention can be utilized with any number of subgroups 172 configured any number of ways.

Associated with each bin 128 (e.g. bin 0, bin 1, bin 2 . . . bin n) is a plurality of tracking bits 174, with each bin bit associated with a particular dynamic state subgroup 172. When a tracking bit 174 for a particular bin 128 is “set,” it is an indication that some state variable within that subgroup 172 (and for that particular bin 128, e.g., bin n) has changed since the time a primitive 162 was last output to that bin 128. Conversely, a “cleared” tracking bit 174 indicates that the associated dynamic state subgroup 172 for that bin 128 has not changed since the time a primitive 162 was last output to that bin 128. In a typical implementation, a per-bin, 4-bit “tracking bit” vector 174 is used to track changes to the four state groups 172. The “texture map”, “texture blend”, “basic state” and “slow state” subgroups each typically contain 512 or 1024 bins. With 512 bins, this amounts to 2K bits total (4-bit vector per bin*512 bins). With 1024 bins, this amounts to 4K bits total (4-bit vector per bin*1024 bins).

Initially, all tracking bits 174 are “set” in order to initialize each bin 128 with a complete complement of dynamic state. In particular, prior to placing a primitive 162 in a bin 128, the tracking bits 174 associated with that bin 128 are examined, and the current state corresponding to set tracking bits 174 is inserted in the bin 128 before the primitive 162. Then the tracking bits 174 for that bin 128 are cleared. In a typical embodiment, many of the state bits 174 do not change very often. However, any of the bits 174 that have changed over time must be identified and issued, or a larger group of them issued, to the bin 128 such that the precise state for the triangle can be maintained during rasterization.

In particular, the state groups 172 shown in FIG. 4 include:

(1) “Basic State” Subgroup 176—The state variables associated with the Basic State tracking bit array, include but are not limited to, vertex-buffer, vertex-format, setup, texel stream and pixel pipeline state variables. The state variables are typically arranged into a fixed sequence of words. In one particular embodiment, any change to a basic state variables will require all the words to be issued to the required bins 128 although one skilled in the art will recognize that other configurations may be used as well. In another embodiment, more granular tracking of basic state changes for either all bins 128 or a smaller subset of “open” bins 128 is implemented.

(2) “Texture Map” Subgroup 178—The state variables associated with the Texture Map State tracking bit array, include but are not limited to, most texture map parameters, cube map face enables and texture filter parameters. State variables are output by the graphics-binning engine 126 as part of an instruction. When the Texture Map State tracking bit for a particular bin 128 is found set, the graphics-binning engine 126 will only output the words associated with texture maps that are currently required by the current context settings. The “currently used” maps are determined by the graphics-binning engine 126 by examining the enabled texture blend stages, seeing which texel streams are required as input, and then examining which texture maps are associated with those required texel streams.

(3) “Texture Blend” Subgroup 180—The state variables associated with the Texture Blend State tracking bit array, include but are not limited to, state variables used to control texture map blend stages. In a typical implementation, the state variables include global control and texture blend color, alpha, control stage parameters for controlling one to four texture map blend stage units. These state variables are output by the graphics-binning engine 126 as part of an instruction. When the Texture Blend State tracking bit for a particular bin 128 is found set, the graphics-binning engine 126 will only output those words required by the current setting of the “number of enabled texture blend stages” derived state variable.

(4) “Slow State” Subgroup 182—The state variable associated with the Slow State tracking bit array is a “Slow State Pointer.” Referring to FIGS. 2 and 5, slow state pointer 192 indirectly controls any state pointer not included in the other state subgroups such as the Basic, Texture Blend and Texture Map state subgroups 176, 178 and 180. In a typical embodiment, low-level state change and/or infrequently changing instructions are placed in the slow state buffers 166 and the pointers 192 are only passed into those slow state buffers 166 via an instruction 202.

“Slow state” subgroup 182 includes, but is not limited to the remaining non-pipelined (and a few low-frequency pipelined) state variables not included in the other subgroups 176, 178 and 180. Changes to “slow state” state variables are not directly sent to the graphics-binning engine 126. Rather, slow state buffers 166 containing initial+delta state changes for these variables are built such that a single pointer 192 referencing one of these slow state buffers 166 is sufficient to define the current state of all the “slow” state variables. This way, only the slow state pointer needs to be sent to the graphics-binning engine 126. Changes to the slow state pointer 192 will be placed in bins 128 as required, and during rendering will initiate the required reads of the slow state buffers 166 to update slow state variables. The graphics-rendering engine 136 will execute the buffered instructions between the previous and new values of the slow state pointers 192 although only if the new value falls between the previous value and the end of the page being rendered. Otherwise the graphics-rendering engine 136 will execute the instructions 192 from the top of the page specified by the new slow state pointer 192 up to but not including the Dword specified by the new slow state pointer 192. This will thereby set all slow state variables to their initial values and then apply all delta state changes up to but not including the Dword specified by the new slow state pointer 192.

FIG. 5 illustrates a block diagram of an embodiment 190 of a slow state block 166 and slow state pointer 192. The slow state block 166 is of a programmable size and includes and begins with a series of commands 194 that initialize all slow state variables. Following that can be a series of incremental changes to specific slow state variables. At any point, the value of the slow state pointer 192 corresponds to a complete specification of all slow state variables. In particular, execution of the slow state block 166 from the beginning of the slow state block 166 up to and including the slow state pointer 192 will cause all slow state values to take on a known value. A subsequent increment of the slow state pointer 196 (within the same slow state block 166) will simply add the incremental changes from the previous slow state pointer (for example, pointer 192) to the new slow state pointer (for example, pointer 196). The slow state values are brought to a new, known value.

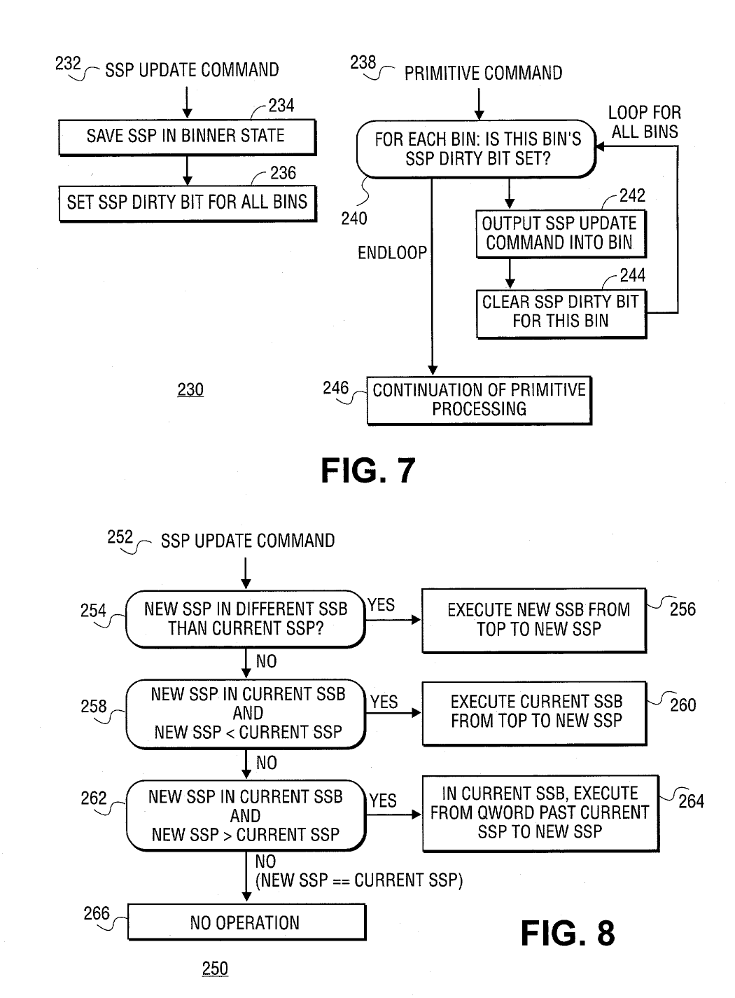

FIG. 6 illustrates a flow diagram of an embodiment of a process for generating slow state blocks during scene binning. Optimized versions of state-setting graphics instructions are used to independently update each of the dynamic state variable subgroups 172, including the slow state pointer subgroup 182. By including these optimized instructions within the bins 128, the complexity and latency of reading indirect state data is greatly reduced, thus increasing performance while lowering cost. In particular, FIG. 7 illustrates an algorithm used by driver software to generate slow state blocks during scene binning.

As previously noted and shown in FIG. 5, slow state variables (SSVs) are maintained in a global (i.e., scene-scoped) list of slow state blocks 166. Initially, if a slow state variable change is encountered (step 212), whether there is a currently open slow state block 190 is determined (step 214). If there is a currently available slow state block (step 214), it is determined whether there is room for the slow state variable change in the currently open slow state block (step 216).

If there is no room for the slow state value change in the currently open slow state block (step 216), a new slow state block is allocated from memory (step 218). The new slow state block is initialized with the current values of all slow state values, including the new value of the changed slow state value (step 220). The slow state value change is then inserted into the currently open slow state block (step 222). The slow state pointer update command is then sent to the graphics-binning engine 126 with a slow state pointer pointing to last valid slow state value in the slow state block (step 224).

If there is room for the slow state value change in the currently open slow state block (step 216), the slow state value change is then inserted into the currently open slow state block (step 222). The slow state pointer update command is then sent to the graphics-binning engine 126 with a slow state pointer pointing to last valid slow state value in the slow state block (step 224).

If there is a change to a slow state variable (step 212) but no currently available slow state block (step 214), a new slow state block is allocated from memory (step 218). The new slow state block is initialized with the current values of all slow state values, including the new value of the changed slow state value (step 220). The slow state value change is then inserted into the currently open slow state block (step 222). The slow state pointer update command is then sent to the graphics-binning engine 126 with a slow state pointer pointing to last valid slow state value in the slow state block (step 224).

FIG. 2 illustrates an embodiment of slow state memory blocks 166, slow state pointer update instruction 202, graphics-binning engine 126 and graphics-rendering engine 136. The graphics primitive and state-setting instruction stream 124, including slow state pointer update instruction 202, is initially applied to graphics-binning engine ring buffer 125 associated with graphics-binning engine 126. The graphics-binning engine 126 parses scene input list 124 and determines which zone(s) 164 each primitive 162 intersects. The graphics-binning engine 126 maintains the current graphics state by parsing associated state-setting instructions 124 including slow state pointer update instruction 202. Prior to placing a primitive command in any given bin 128, the graphics-binning engine 126 precedes the primitive command in the bin 128 with the state-setting instructions 124.

In particular, a command, hereinafter referred to as the “Slow State Pointer Update” instruction 202, is used to set the slow state pointer 192 within the graphics context. It is accepted by both the graphics-binning engine 126 and graphics-rendering engine 136. A typical Slow State Pointer Update instruction 202, presented in a Dword format, is described below:

| Dword | Bits | Description |
|---|---|---|
| 0 | 31:29 | Instruction Type = MI_INSTRUCTION |
| | 28:23 | MI Instruction Opcode = SSP UPDATE |
| | 22:10 | Reserved: MBZ |
| | 9:8 | Slow State Block (SSB) Size: This field specifies |
| | | the “block size” to be used when determining where |
| | | to start the execution of the SSB. The block size, |
| | | combined with the SSP included in this instruction, |
| | | defines a size-aligned SSB. |
| 1 | 31:3 | Slow State Pointer (SSP): This field specifies a |
| | | Qword-aligned address with an SSB. This pointer |
| | | references the last Qword in the block to be |
| | | executed-i.e., the Qword pointed to is to be |
| | | included in the execution. |
| | 2:0 | Reserved: MBZ |

The Slow State Pointer update instruction 202 includes a Slow State Pointer state variable (Dword 1, bits 31:3) as the main data content. The Slow State Pointer update instruction 202 also includes Slow State Buffer size (Dword 2, bits 9:8) data for comparing previous and current Slow State Pointer values (Slow State Buffers are naturally size-aligned). The Slow State Buffer size field provides the driver with the ability to program the size of the Slow State Buffer, in order to fine-tune the average processing time of a Slow State Pointer update instruction 202 during rendering.

Examples of particular operations are discussed with reference to the dword data format. However, one skilled in the art will recognize that the Slow State Pointer Update command can be presented in several different data formats and is not limited to the Dword format discussed herein. For example, in one embodiment, the graphics-binning engine 126 and graphics-rendering engine 136 manipulates 64-bit data groups. In this embodiment, packed data can be in one of three formats: “packed double-word” (dword) format, “packed byte” format, or “packed word” format. Packed data in a packed dword format includes two separate 32-bit data elements. Packed data in a packed byte format includes eight separate 8-bit data elements. Packed data in a packed word format includes four separate 16-bit data elements.

Slow state buffers 166 store initial and delta state changes for the slow state variables. A single pointer 192 into one of these slow state buffers 166 is sufficient to define the current state of all the slow state variables. The slow state buffers 166 may be located in either state memory 108 or a dedicated memory. In a typical embodiment, low-level state changes and/or infrequently changing instructions are placed in the slow state buffers 166 and pointers 192 are only passed into those slow state buffers 166 via an instruction 167. Once all the primitives and state instructions including slow state pointers 192 are binned, a second pass is made to render the scene one zone 164 at a time. The bins 128 are rendered to generate the final image, with each scene rendered one zone 164 at a time. During rendering, the graphic rendering engine 136 initiates the required reads of the slow state buffers 166, based upon the binned slow state pointer 192, to update slow state variables. The graphics-rendering engine 136 will execute the buffered instructions between the previous and new values of the slow state pointers 192. In a typical implementation, if a Slow State tracking bit 183 for bin 0 indicates a change, the slow state “pointer” 192 is output to the bin 128. The Slow State tracking bit 183 is then cleared. If the Slow State tracking bit 183 does not indicate a change, the slow state pointer is not output to bin 0.

Embodiments of the present invention examine delta state changes and update state and per-bin tracking bits 174 (steps 212-222). The graphics-binning engine 126 prevents unnecessary broadcasting of all state changes to all bins 128 by maintaining and tracking changes to states on a per-bin 128 and per-subgroup 172 basis. The state for a bin 128 is updated advantageously just prior to the primitive instruction being placed in the bin 128. Multiple changes occurring within the same state subgroup 172 between primitive instructions being binned are collapsed into one subgroup change output to the bin 128.

Embodiments of the present invention use the stored current dynamic state and the per-bin tracking bits 174 to efficiently manage state changes during the scene capture phase. By tracking state changes on a per bin 128 and per state group 172 basis, the graphics-binning engine 126 will also only update those state subgroups 172 that have changed for a particular intersected bin 128 since the last time a primitive 162 was placed in that bin 128.

FIG. 7 illustrates a flow diagram of an embodiment of a process for the graphics-binning engine 126 to handle slow state pointer update commands 202 during scene binning.

In particular, upon receipt of a slow state pointer update command 202, the slow state pointer is saved in the binner state (step 234) and then the slow state pointer tracking bits are set for all bins (step 236).

Upon receipt of a primitive command (step 238), the graphics-binning engine 126 determines if the bin's slow state pointer's tracking bit is set (step 240) for each bin. If the slow state pointer's tracking bit is set (step 240), primitive processing is continued (step 246).

For primitive commands (step 238), if the slow state pointer's tracking bit is not set (step 240), the slow state pointer update command is output to the bin (step 242). The slow state tracking bit is then cleared for the bin (step 244). Steps 242 and 244 are continued for all bins until the bin's slow state tracking bit is set (step 240). At that point, primitive processing is continued (step 246).

FIG. 8 illustrates a flow diagram of an embodiment 250 of a process for the graphics-rendering engine 136 to handle slow state update commands (step 252). If the new slow state pointer is in a different slow state block than the current slow state pointer (step 254), the new slow state block is executed from the top to the new slow state pointer (step 256).

If the new slow state pointer is not in a different slow state block than the current slow state pointer (step 254), than it's determined (a) whether the new slow state pointer is in the current slow state block and (b) whether the new slow state pointer is less than the current slow state pointer (step 258). If both conditions (a) and (b) are met (step 258), the new slow state block is executed from the top to the new slow state pointer (step 256).

If both conditions (a) and (b) are not met (step 258), than it's determined (a) whether the new slow state pointer is in the current slow state block and (b) whether the new slow state pointer is greater than the current state pointer (step 262). If both conditions (a) and (b) are met (step 262), in the current slow state block, the Qword from the past current slow state pointer to the new slow state pointer is executed (step 264).

If both conditions (a) and (b) are not met (step 262), the graphics-rendering engine 136 performs no further operations with respect to the slow state pointer command (step 266). In such case the new slow state pointer is the same as the current slow state pointer.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A method for managing state variables for rendering primitives, comprising:
defining a plurality of memory areas for storing instructions and current state information associated with the primitives;
defining state variables associated with the primitives;
sorting state variables into a plurality of subgroups;
associating each of the plurality of memory areas with a plurality of tracking bits, wherein each tracking bit is associated with a subgroup and one of the plurality of memory areas;
setting the tracking bit in response to a change in a state variable since the primitive instructions were previously output to the memory areas; and
outputting current state information associated with the subgroup into one of the plurality of memory areas in response to the tracking bit being set.

2. The method of claim 1 further comprising:
clearing the tracking bit after the current state information has been output to the one of the plurality of memory areas.

3. The method of claim 1 wherein sorting state variables into a plurality of subgroups further comprises:
sorting state variables associated with slow state functions.

4. The method of claim 1 further comprising:
defining a plurality of additional memory areas for storing state information;
defining a reference for the plurality of additional memory areas; and
storing selected state group information into the plurality of additional memory areas.

5. The method of claim 4 wherein outputting current state information associated with the subgroup into one of the plurality of memory areas in response to the subgroup being set further comprises:
outputting the reference associated with the subgroup into one of the plurality of memory areas when the tracking bit is set; and
based on the reference, retrieving referenced information stored in one of the plurality of additional memory areas during rendering.

6. The method of claim 5 wherein storing selected state group information into the additional memory areas further comprises:
storing state variables associated with slow state functions into the plurality of additional memory areas.

7. The method of claim 6 wherein defining a reference for the additional memory areas further comprises:
defining a pointer to the additional memory areas where slow state information is stored.

8. An apparatus for rendering a scene including primitives, comprising:
a plurality of binning memory areas associated with regions that are intersected by primitives;
a tracking memory area for storing indicators of state variables that been affected since primitive instructions were previously output to the memory areas;
a binning engine, responsive to the tracking indicators, for binning current state information of state variables; and
a rendering engine for rendering the current information stored in the memory areas.

9. The apparatus of claim 8 wherein the current information comprises state variables that have changed since primitive instructions were previously output to the memory areas.

10. The apparatus of claim 8 wherein the current information comprises a reference.

11. The apparatus of claim 9 wherein the state variables are associated with at least one state group.

12. The apparatus of claim 11 wherein the at least one state group comprises slow state functions.

13. The apparatus of claim 10 further comprising:
a plurality of additional memory areas.

14. The apparatus of claim 13 wherein the plurality of additional memory areas stores slow state variables.

15. The apparatus of claim 14 wherein the reference comprises a pointer into the additional memory areas.

16. The apparatus of claim 15 wherein the binning engine, responsive to the tracking indicators, bins the reference in one of the plurality of binning memory areas.

17. The apparatus of claim 16 wherein the rendering engine utilizes the reference to retrieve slow state information from at least one of the plurality of additional memory areas.

18. A machine readable medium having stored therein a plurality of machine readable instructions executable by a processor to manage states for rendering primitives, the machine readable instructions comprising:
instructions to define a plurality of memory areas for storing instructions and current state information associated with the primitives;
instructions to define state variables associated with the primitives;
instructions to sort state variables into a plurality of subgroups;
instructions to associate each of the plurality of memory areas with a plurality of tracking bits, wherein each tracking bit is associated with a subgroup and one of the plurality of memory areas;
instructions to set the tracking bit in response to a change in a state variable since the primitive instructions were previously output to the memory areas; and
instructions to output current state information associated with the subgroup into one of the plurality of memory areas in response to the tracking bit being set.

19. The machine readable medium of claim 18 further comprising:
instructions to clear the tracking bit after the current state information has been output to the one of the plurality of memory areas.

20. The machine readable medium of claim 18 wherein instructions to sort state variables into a plurality of subgroups further comprises:
instructions to sort state variables associated with slow state functions.

21. The machine readable medium of claim 18 further comprises:
instructions to define a plurality of additional memory areas for storing state information;
instructions to define a reference for the plurality of additional memory areas; and
instructions to store selected state group information into the plurality of additional memory areas.

22. The machine readable medium of claim 21 wherein instructions to output current state information associated with the subgroup into one of the plurality of memory areas in response to the subgroup being set further comprises:
instructions to output the reference associated with the subgroup into one of the plurality of memory areas when the tracking bit is set.; and
instructions, based on the reference, to retrieve referenced information stored in one of the plurality of additional memory areas during rendering.

23. The machine readable medium of claim 22 wherein instructions to store selected state group information into the additional memory areas further comprises:
instructions to store state variables associated with slow state functions into the plurality of additional memory areas.

24. The machine readable medium of claim 23 wherein instructions to define a reference for the additional memory areas further comprises:
instructions to define a pointer to the additional memory areas where slow state information is stored.
